(19) United States
(12) Patent Application Publication
(10) Pub. No.: US 2023/0403180 A1
(43) Pub. Date: Dec. 14, 2023

(54) COMMUNICATION APPARATUS, COMMUNICATION SETTING METHOD, AND NON-TRANSITORY STORAGE MEDIUM

(71) Applicant: NEC Corporation, Tokyo (JP)

(72) Inventor: Bin Zheng, Tokyo (JP)

(73) Assignee: NEC Corporation, Tokyo (JP)

(21) Appl. No.: 18/204,269

(22) Filed: May 31, 2023

(30) Foreign Application Priority Data
Jun. 10, 2022 (JP) 2022-094370

(51) Int. Cl. H04L 12/46; H04L 45/24

(52) U.S. Cl. CPC H04L 12/4666; H04L 45/245

(57) ABSTRACT

For communicably connecting with an opposing apparatus using VLANs on multiple communication pathways, communication addresses of the opposing apparatus and relay apparatuses located on the communication pathways are acquired. Used VLAN-IDs already being utilized for configuring other VLANs by the opposing apparatus and the relay apparatuses located on the communication pathways are acquired. A VLAN-ID that is not being utilized is identified based on the used VLAN-IDs that are already being utilized for configuring other VLANs by a local apparatus, the relay apparatuses, and the opposing apparatus. The identified VLAN-ID is used to set settings for communicably connecting the opposing apparatus and the relay apparatuses on a single communication pathway using a new VLAN.

This application is based upon and claims the benefit of priority from Japanese patent application No. 2022-094370, filed Jun. 10, 2022, the disclose of which is incorporated herein in its entirety by reference.

### TECHNICAL FIELD

The present disclosure relates to a communication apparatus, a communication setting method, and a non-transitory storage medium.

### BACKGROUND ART

There is technology for constructing multi-traffic aggregation (MTA) systems by multiple communication pathway links integrating multiple communication pathways including wired communication and wireless communication across multiple apparatuses.

In multi-traffic aggregations, multiple relay links, which are communication pathways, are constructed between communication apparatuses. A relay link refers to a path or a link between two primary nodes, which are embodiments of communication apparatuses, with another node, such as a relay apparatus, which is another communication apparatus, located on the path or link. In order to construct a single relay link, it is required that the same VLAN (Virtual Local Area Network) ID be set in each of the multiple apparatuses. As the VLAN-ID to be set, it is not possible to designate a VLAN-ID that is being used for a service other than user traffic or MTA. It is required that a different VLAN-ID be set for each relay link.

Patent Document 1 (Japanese Unexamined Patent Application Publication No. 2006-345088) discloses, as related technology, technology for dynamically assigning an arbitrary or unique VLAN-ID to a user terminal that has connected to a network, and enabling communication with the assigned VLAN-ID.

### SUMMARY

Therefore, an example of an objective of the present disclosure is to provide a communication apparatus, a communication setting method, and a non-transitory storage medium for solving the above-mentioned problem.

According to an example of a first aspect disclosed herein, a communication apparatus is provided with at least one memory configured to store instructions; and at least one processor configured to execute the instructions to: acquire, for communicably connecting with an opposing apparatus using Virtual Local Area Networks (VLANs) on multiple communication pathways, communication addresses of the opposing apparatus and relay apparatuses located on the communication pathways; acquire used VLAN-IDs already being utilized for configuring other VLANs by the opposing apparatus and the relay apparatuses located on the communication pathways; identify a VLAN-ID that is not being utilized based on the used VLAN-IDs that are already being utilized for configuring other VLANs by a local apparatus, the relay apparatuses, and the opposing apparatus; and set, using the identified VLAN-ID, settings for communicably connecting the opposing apparatus and the relay apparatuses indicated by the communication addresses on a single communication pathway using a new VLAN.

According to an example of a second aspect disclosed herein, a communication setting method includes acquiring, for communicably connecting with an opposing apparatus using VLANs on multiple communication pathways, communication addresses of the opposing apparatus and relay apparatuses located on the communication pathways; acquiring used VLAN-IDs already being utilized for configuring other VLANs by the opposing apparatus and the relay apparatuses located on the communication pathways; identifying a VLAN-ID that is not being utilized based on the used VLAN-IDs that are already being utilized for configuring other VLANs by a local apparatus, the relay apparatuses, and the opposing apparatus; and setting, using the identified VLAN-ID, settings for communicably connecting the opposing apparatus and the relay apparatuses indicated by the communication addresses on a single communication pathway using a new VLAN.

According to an example of a third aspect disclosed herein, a non-transitory computer-readable storage medium that stores a program that causes a computer in a communication apparatus to execute processes, the processes including acquiring means for acquiring, for communicably connecting with an opposing apparatus using VLANs on multiple communication pathways, communication addresses of the opposing apparatus and relay apparatuses located on the communication pathways; acquiring used VLAN-IDs already being utilized for configuring other VLANs by the opposing apparatus and the relay apparatuses located on the communication pathways; identifying a VLAN-ID that is not being utilized based on the used VLAN-IDs that are already being utilized for configuring other VLANs by a local apparatus, the relay apparatuses, and the opposing apparatus; and setting, using the identified VLAN-ID, settings for communicably connecting the opposing apparatus and the relay apparatuses indicated by the communication addresses on a single communication pathway using a new VLAN.

### BRIEF DESCRIPTION OF THE DRAWINGS

FIG. 1 is a schematic configuration diagram of a communication system according to the present embodiment.

FIG. 2 is a hardware configuration diagram of a communication apparatus according to the present embodiment.

FIG. 3 is a functional block diagram of a communication apparatus according to the present embodiment.

FIG. 4 is a diagram indicating a list of IP addresses of communication apparatuses constituting respective communication pathways according to the present embodiment.

FIG. 5 is a first diagram indicating the processing flow in the communication system according to the present embodiment.

FIG. 6 is a diagram indicating a summary of an available VLAN discovery process according to the present embodiment.

FIG. 7 is a second diagram indicating the processing flow in the communication system according to the present embodiment.

FIG. 8 is a diagram indicating the minimum configuration of a communication apparatus.

FIG. 9 is a diagram indicating the processing flow in the communication apparatus according to the minimum configuration.

### EXAMPLE EMBODIMENT

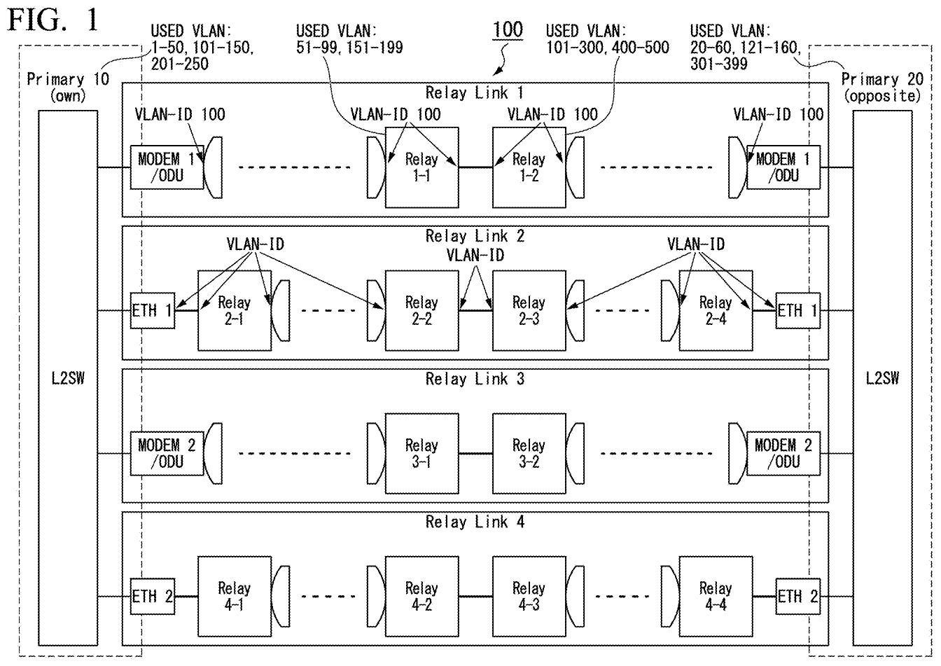

FIG. 1 is a schematic configuration diagram of a communication system provided with a communication apparatus according to the present embodiment.

In the communication system 100 illustrated in FIG. 1, a communication apparatus (Primary) 10 and a communication apparatus (Primary) 20, which is an opposing apparatus, are communicably connected.

The communication apparatus 10 and the communication apparatus 20 may include an L2SW (Layer 2 SWitch). The communication apparatus 10 and the communication apparatus 20 are communicably connected by multiple communication pathways. Each communication pathway is called a relay link.

The relays link may communicate by different communication modes, such as wired modes and wireless modes. For example, each relay link may include wireless communication apparatuses (MODEM/ODU; MOdulation and DEModulation/OutDoor Unit 1, 2) or wired communication apparatuses (ETH 1, 2). There may be one or multiple relay apparatuses (Relay), etc. on each relay link.

In the example in FIG. 1, a relay apparatus Relay 1-1 and a relay apparatus Relay 1-2 relay communications on Relay Link 1, which is a first communication pathway between the communication apparatus 10 and the communication apparatus 20. A relay apparatus Relay 2-1, a relay apparatus Relay 2-2, a relay apparatus Relay 2-3, and a relay apparatus Relay 2-4 relay communication on Relay Link 2, which is a second communication pathway between the communication apparatus 10 and the communication apparatus 20. A relay apparatus Relay 3-1 and a relay apparatus Relay 3-2 relay communications on Relay Link 3, which is a third communication pathway between the communication apparatus 10 and the communication apparatus 20. A relay apparatus Relay 4-1, a relay apparatus Relay 4-2, a relay apparatus Relay 4-3, and a relay apparatus Relay 4-4 relay communications on Relay Link 4, which is a fourth communication pathway between the communication apparatus 10 and the communication apparatus 20. Each relay apparatus is also an embodiment of communication apparatuses. The relay apparatuses Relay may also be called relay apparatuses 30.

The communication apparatus 10 and the communication apparatus 20 communicate by integrating the four above-mentioned communication pathways Relay Link 1 to 4 to configure a multi-traffic aggregation (MTA) system. When configuring the MTA, it is required to set a VLAN-ID to a communication port in each of the communication apparatuses. Suppose that VLAN-IDs for other communication have already been set in each of the communication apparatuses before communicating by integrating the communication pathways Relay Link 1 to 4 to configure the MTA. These will be referred to as used VLAN-IDs. An ID refers to an identifier. As an example, suppose that the communication apparatus 10 constituting the communication pathway Relay Link 1 is already using the VLAN-IDs 1-50, 101-150, and 201-250. Suppose that the relay apparatus Relay 1-1 constituting the communication pathway Relay Link 1 is already using the VLAN-IDs 59-99 and 151-199. Suppose that the relay apparatus Relay 1-2 constituting the communication pathway Relay Link 1 is already using the VLAN-IDs 101-300 and 400-500. Suppose that the communication apparatus 20 constituting the communication pathway Relay Link 1 is already using the VLAN-IDs 20-60, 121-160, and 301-399. it is required that each of the communication apparatuses constituting the communication pathway Relay Link 1 set a VLAN-ID other than these used VLAN-IDs in a communication module in a local apparatus when configuring the MTA. Similarly for the other communication pathways Relay Link, when configuring the MTA, it is required to identify a VLAN-ID other than a used VLAN-ID, and set the identified VLAN-ID in each of the communication apparatuses constituting that communication pathway Relay Link. That is, in each of the communication apparatuses in the multiple communication pathways Relay Link configuring the MTA, it is required to set a new VLAN-ID for each of the communication pathways Relay Link so that the VLAN-IDs do not overlap.

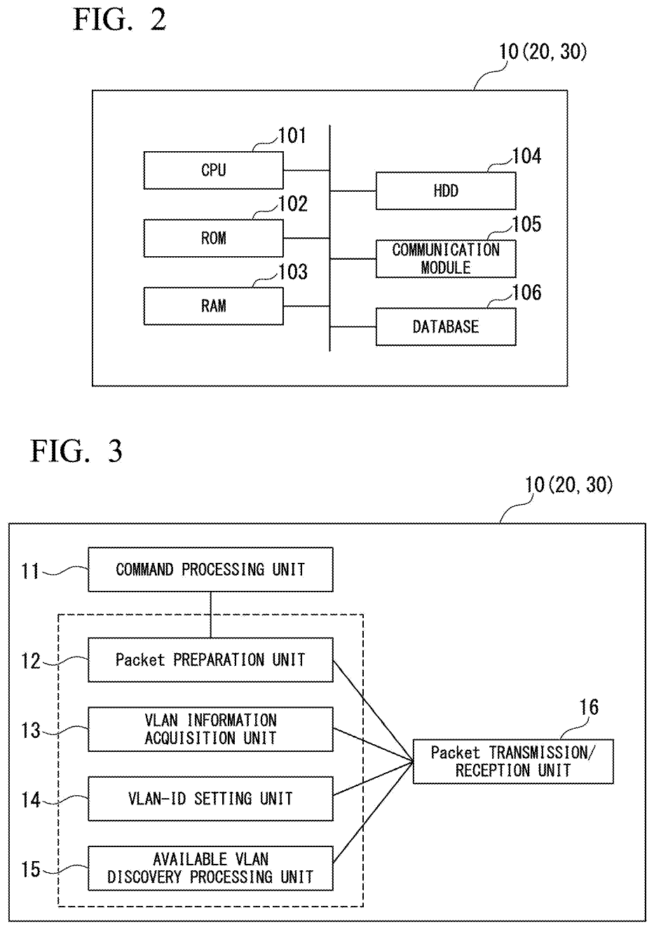

FIG. 2 is a hardware configuration diagram of a communication apparatus.

Each of the communication apparatuses, such as the communication apparatuses 10, 20 and the relay apparatuses 30 (relay apparatuses Relay 1-1, 1-2, . . . , 4-4), is a computer provided with hardware such as a CPU (Central Processing Unit) 101, a ROM (Read-Only Memory) 102, a RAM (Random Access Memory) 103, an HDD (Hard Disk Drive) 104, a communication module 105, and a database 106.

FIG. 3 is a functional block diagram of a communication apparatus.

The communication apparatus (Primary) 10 is provided with the functions indicated in FIG. 3. Specifically, the CPU 101 in the communication apparatus 10 executes a program for controlling the MTA. As a result thereof, the communication apparatus 10 performs the respective functions of a command processing unit 11, a packet preparation unit 12, a VLAN information acquisition unit 13, a VLAN-ID setting unit 14, an available VLAN discovery processing unit 15, and a packet transmitting/receiving unit 16.

The command processing unit 11 interprets pathway information designated by an operator and requests the packet preparation unit 12 to prepare a VLAN information request packet.

The packet preparation unit 12 prepares packets such as VLAN information request packets, VLAN setting request packets, transfer packets, response packets, and setting result (success/failure) packets in response to the content of requests from other functional units and the like, and transmits the packets to the communication apparatuses that are the destinations.

The VLAN information acquisition unit 13 acquires used VLAN-IDs.

The VLAN-ID setting unit 14 references an LLDP database, identifies a communication port connected with another communication apparatus, and sets the designated VLAN-ID to that communication port.

The available VLAN discovery processing unit 15 identifies VLAN-IDs that are not being utilized based on collected used VLAN-ID information.

The packet transmission/reception unit 16 requests a prescribed functional unit to implement processing in accordance with the content of packets received from other communication apparatuses.

The respective communication apparatuses such as the communication apparatus 10, the communication apparatus 20, and the relay apparatuses 30 (Relay 1-1, 1-2, . . . , 4-4) may be provided with the respective functions indicated in FIG. 3. The relay apparatuses 30 (Relay 1-1, 1-2, . . . , 4-4) may be provided with just some of the functions indicated in FIG. 3. For example, the relay apparatuses 30 (Relay 1-1, 1-2, . . . , 4-4) do not need to be provided with functions such as the command processing unit 11 and the available VLAN discovery processing unit 15 among the functions indicated in FIG. 3.

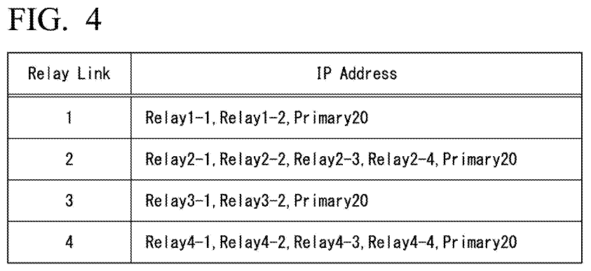

FIG. 4 is a diagram indicating a list of IP addresses of communication apparatuses constituting the respective communication pathways.

When configuring the MTA with the four communication pathways Relay Link 1 to 4 described above, an operator inputs, to the communication apparatus 10, the IP addresses (MTA group pathway information) of the respective communication apparatuses constituting the communication pathways Relay Link 1 to 4 indicated in FIG. 4. Then, when the operator instructs the communication apparatus 10 to initiate the process, the communication apparatus 10 initiates the process of configuring the MTA and executes an automatic VLAN-ID setting command.

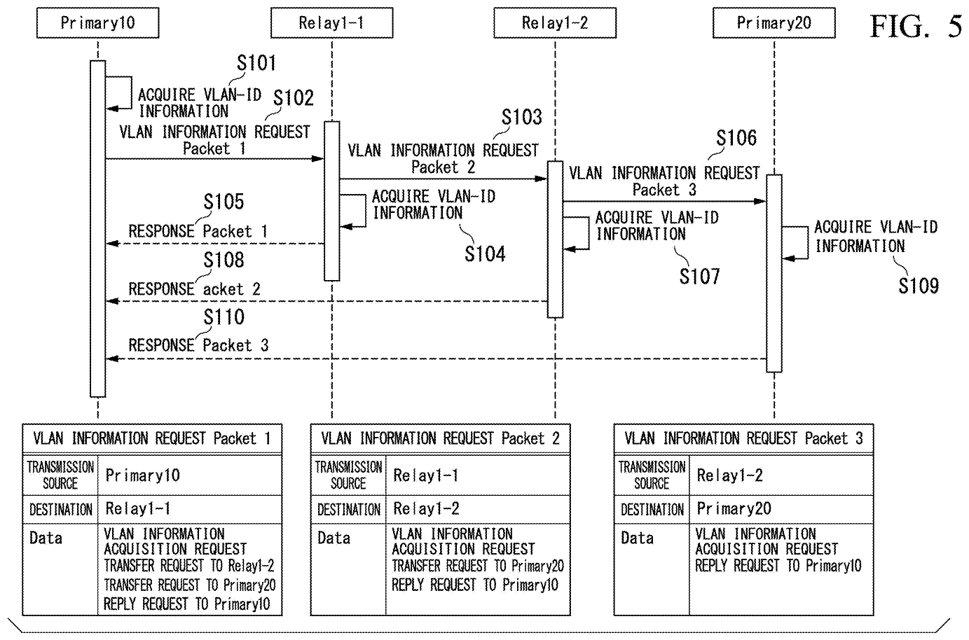

FIG. 5 is a first diagram indicating the processing flow in the communication system 100.

Next, the processes in the communication system 100 will be explained in order.

It will be assumed that the network connections of the communication system 100 illustrated in FIG. 1 are already constructed. As a preliminary condition, the LLDP (Link Layer Discovery Protocol) functions of the respective communication apparatuses are enabled. LLDP is a protocol for detecting adjacent apparatuses and exchanging identification information and settings information (for example, information such as IP addresses and port numbers) of the communication apparatuses.

An operator inputs, to the communication apparatus 10, MTA group pathway information indicating the IP addresses indicated in FIG. 4. Then, the command processing unit 11 in the communication apparatus 10 executes an automatic VLAN-ID setting command.

The packet preparation unit 12 in the communication apparatus 10 acquires used VLAN-ID (used VLAN-ID: a VLAN ID that has already been assigned to one of the ports) information for the local apparatus (step S101). The packet preparation unit 12 prepares a VLAN information request Packet 1. The VLAN information request Packet 1 includes the IP address of the local apparatus (Primary) 10 as transmission source information, includes the IP address of the relay apparatus Relay 1-1 directly connected to the local apparatus as destination information, and includes information indicating that the packet is a VLAN information acquisition request, a transfer request to the Relay 1-2, a transfer request to the communication apparatus (Primary) 20, and a request for a reply to the communication apparatus (Primary) 10 as message data. The packet transmission/reception unit 16 of the communication apparatus (Primary) 10 transmits the VLAN information request Packet 1 to the relay apparatus Relay 1-1 (step S102).

The relay apparatus Relay 1-1 receives the VLAN information request Packet 1. The packet preparation unit 12 of the relay apparatus Relay 1-1 prepares a VLAN information request Packet 2 based on the transfer information indicating a “transfer request to relay apparatus Relay 1-2” in the message in the received VLAN information request Packet 1. At this time, the packet preparation unit 12 of the relay apparatus Relay 1-1 prepares the VLAN information request Packet 2 by rewriting the transmission source of the VLAN information request Packet 1 to be the relay apparatus Relay 1-1, which indicates the local apparatus, rewriting the destination to be the relay apparatus Relay 1-2, and deleting the “transfer request to relay apparatus Relay 1-2”, which is a request indicating the local apparatus, from the data in the message. The packet transmission/reception unit 16 of the relay apparatus Relay 1-1 transmits the VLAN information request Packet 2 to the relay apparatus Relay 1-2 (step S103). Additionally, the VLAN information acquisition unit 13 in the relay apparatus Relay 1-1 reads the reply destination information indicating a “reply request to Primary 10” in the message in the received VLAN information request Packet 1, and acquires the used VLAN-ID information of the local apparatus (step S104). The packet preparation unit 12 of the relay apparatus Relay 1-1 generates a response Packet 1 including the used VLAN-ID of the local apparatus. The packet transmission/reception unit 16 of the relay apparatus Relay 1-1 sends the response Packet 1 back to the communication apparatus 10 (step S105).

The relay apparatus Relay 1-2 receives the VLAN information request Packet 2. The packet preparation unit 12 of the relay apparatus Relay 1-2 prepares a VLAN information request Packet 3 based on the transfer information indicating a “transfer request to communication apparatus (Primary) 20” in the message in the received VLAN information request Packet 2. At this time, the packet preparation unit 12 of the relay apparatus Relay 1-2 prepares the VLAN information request Packet 3 by rewriting the transmission source of the VLAN information request Packet 3 to be the relay apparatus Relay 1-2, which indicates the local apparatus, rewriting the destination to be the communication apparatus (Primary) 20, and deleting the “transfer request to communication apparatus (Primary) 20” from the data in the message. The packet transmission/reception unit 16 of the relay apparatus Relay 1-2 transmits the VLAN information request Packet 3 to the communication apparatus (Primary) 20 (step S106). Additionally, the VLAN information acquisition unit 13 in the relay apparatus Relay 1-2 reads the reply destination information indicating a “reply request to Primary 10” in the message in the received VLAN information request Packet 2, and acquires the used VLAN-ID information of the local apparatus (step S107). The packet preparation unit 12 of the relay apparatus Relay 1-2 generates a response Packet 2 including the used VLAN-ID of the local apparatus. The packet transmission/reception unit 16 of the relay apparatus Relay 1-2 sends the response Packet 2 back to the communication apparatus 10 (step S108).

The communication apparatus (Primary) 20 receives the VLAN information request Packet 3. The VLAN information acquisition unit 13 of the communication apparatus (Primary) 20 reads the reply destination information indicating a “reply request to Primary 10” in the message in the received VLAN information request Packet 3, and acquires the used VLAN-ID information of the local apparatus (step S109). The packet preparation unit 12 of the communication apparatus (Primary) 20 generates a response Packet 3 including the used VLAN-ID of the local apparatus. The packet transmission/reception unit 16 of the communication apparatus (Primary) 20 sends the response Packet 3 back to the communication apparatus 10 (step S110).

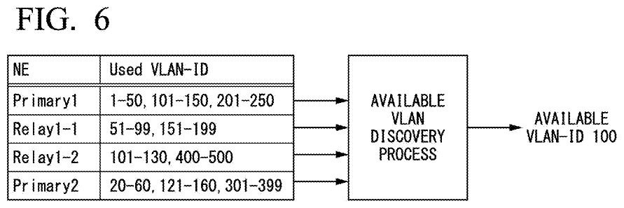

Due to the process above, the communication apparatus (Primary) 10 can acquire information regarding VLAN-IDs that are already being used in each of the communication apparatuses on the communication pathway Relay Link 1. That is, in the example of the communication pathway Relay Link 1 illustrated in FIG. 1, the communication apparatus (Primary) 10 can acquire information regarding the used VLAN-IDs (1-50, 101-150, 201-250) in the communication apparatus (Primary) 10, the used VLAN-IDs (51-99, 151-199) in the relay apparatus Relay 1-1, the used VLAN-IDs (101-130, 400-500) in the relay apparatus Relay 1-2, and the used VLAN-IDs (20-60, 121-160, 301-399) in the communication apparatus (Primary) 20. FIG. 6 shows a list of information regarding VLAN-IDs in each communication apparatus constituting the communication pathway Relay Link 1 acquired by the communication apparatus (Primary) 10. The above-described VLAN-ID information acquisition process is one mode of processing by which, for communicably connecting with an opposing apparatus (communication apparatus 20) using VLANs on multiple communication pathways, the communication addresses of the opposing apparatus (communication apparatus 20) and relay apparatuses 30 located on the communication pathways are acquired, and used VLAN-IDs that are already being utilized to configure other VLANs by the opposing apparatus (communication apparatus 20) and the relay apparatuses 30 located on the communication pathways are acquired.

FIG. 6 is a diagram indicating a summary of an available VLAN discovery process.

The packet transmission/reception unit 16 of the communication apparatus (Primary) 10, upon receiving a response Packet 1, a response Packet 2, and a response Packet 3 in accordance with transmission by the VLAN information request Packet 1, instructs the available VLAN discovery processing unit 15 to perform processes. The available VLAN discovery processing unit 15 in the communication apparatus (Primary) generates lists of used VLAN-ID information (Used VLAN-ID) corresponding to NEs (Network Elements), as indicated in FIG. 6, and compares this information with information on all utilizable VLAN-IDs stored in the local apparatus to identify VLAN-IDs that are not being utilized. The NE indicated in FIG. 6 is a general term for the communication apparatuses constituting the communication pathway Relay Link 1, such as the communication apparatus (Primary) 10, the relay apparatus Relay 1-1, the relay apparatus Relay 1-2, and the communication apparatus (Primary) 20. The available VLAN discovery processing unit 15 of the communication apparatus (Primary) 10 identifies, among the VLAN-IDs that are not being utilized, the VLAN-ID=100 with the smallest number as a VLAN-ID to be utilized in the communication pathway Relay Link 1. Said process is one mode of a process for the available VLAN discovery processing unit 15 to identify a VLAN-ID that is not being utilized based on the used VLAN-IDs that are already being utilized for configuring other VLANs by the local apparatus (communication apparatus 10), the relay apparatuses 30, and the opposing apparatus (communication apparatus 20). Additionally, said process is one mode of a process for the available VLAN discovery processing unit 15 to identify a VLAN-ID that is not being utilized when the used VLAN-IDs have been acquired for the opposing apparatus (communication apparatus 20) and all of the relay apparatuses 30 on the communication pathways.

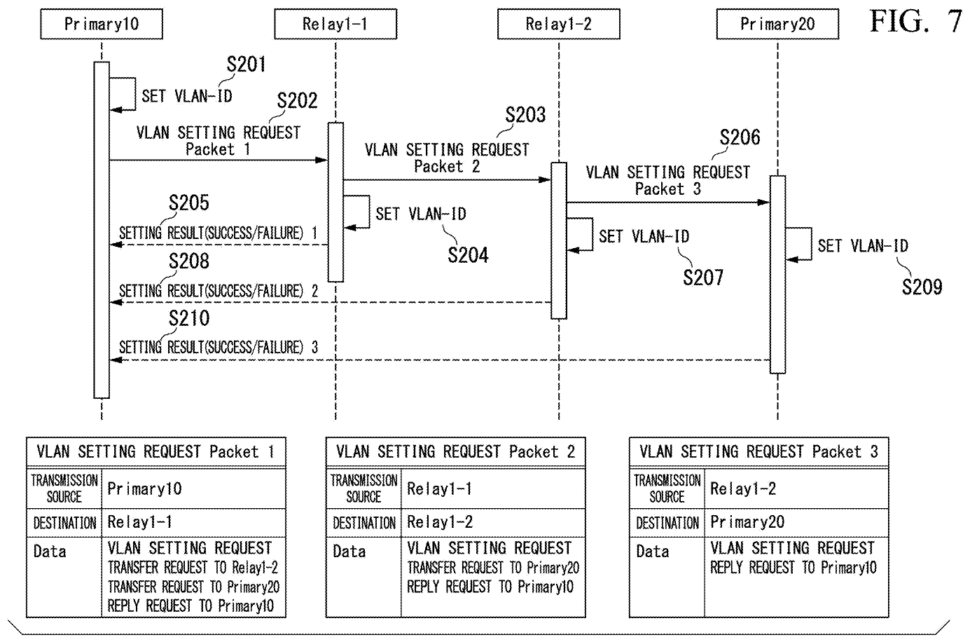

FIG. 7 is a second diagram indicating the processing flow in the communication system 100.

Next, the VLAN-ID setting process will be explained. When the VLAN-ID=100 is identified as the VLAN-ID to be utilized on the communication pathway Relay Link 1 by the above-mentioned process, the VLAN-ID setting unit 14 of the communication apparatus (Primary) 10 sets an available VLAN-ID (e.g., 100) to the port linked to the relay apparatus Relay 1-1 that is connected to the local apparatus in the Relay Link 1 (step S201). Furthermore, the packet preparation unit 12 of the communication apparatus (Primary) 10 prepares a VLAN setting request Packet 1. The VLAN setting request Packet 1 includes the IP address of the local apparatus (Primary) 10 as transmission source information, includes the IP address of the relay apparatus Relay 1-1 directly connected to the local apparatus as destination information, and includes information indicating that the packet is a VLAN setting request, a transfer request to Relay 1-2, a transfer request to the communication apparatus (Primary) 20, and a request for a reply to the communication apparatus (Primary) 10 as message data. The packet transmission/reception unit 16 of the communication apparatus (Primary) 10 transmits the VLAN setting request Packet 1 to the relay apparatus Relay 1-1 (step S202).

The relay apparatus Relay 1-1 receives the VLAN setting request Packet 1. The packet preparation unit 12 of the relay apparatus Relay 1-1 prepares a VLAN setting request Packet 2 based on the transfer information indicating a “transfer request to relay apparatus Relay 1-2” in the message in the received VLAN setting request Packet 1. At this time, the packet preparation unit 12 of the relay apparatus Relay 1-1 prepares the VLAN setting request Packet 2 by rewriting the transmission source of the VLAN setting request Packet 1 to be the relay apparatus Relay 1-1, which indicates the local apparatus, rewriting the destination to be the relay apparatus Relay 1-2, and deleting the “transfer request to relay apparatus Relay 1-2”, which is a request indicating the local apparatus, from the data in the message. The packet transmission/reception unit 16 of the relay apparatus Relay 1-1 transmits the VLAN setting request Packet 2 to the relay apparatus Relay 1-2 (step S203). Additionally, the VLAN-ID setting unit 14 in the relay apparatus Relay 1-1 checks an LLDP data table recorded in the database 106 of the local apparatus and identifies the port number linked to the communication apparatus (Primary) 10 and the port number linked to the relay apparatus Relay 1-2. The VLAN-ID setting unit 14 of the relay apparatus Relay 1-1 sets the VLAN-ID:100 to the ports with the identified port numbers (step S204). When the setting of the VLAN-ID:100 is completed, the packet preparation unit 12 of the relay apparatus Relay 1-1 reads reply destination information indicating a “reply request to Primary 10” in the message in the received VLAN setting request Packet 1, and generates a setting result (success/failure) 1. The packet transmission/reception unit 16 of the relay apparatus Relay 1-1 sends the setting result (success/failure) 1 back to the communication apparatus (Primary) 10 (step S205).

The relay apparatus Relay 1-2 receives the VLAN setting request Packet 2. The packet preparation unit 12 of the relay apparatus Relay 1-2 prepares a VLAN setting request Packet 3 based on the transfer information indicating a “transfer request to communication apparatus (Primary) 20” in the message in the received VLAN setting request Packet 2. At this time, the packet preparation unit 12 of the relay apparatus Relay 1-2 prepares the VLAN setting request Packet 3 by rewriting the transmission source of the VLAN setting request Packet 2 to be the relay apparatus Relay 1-2, which indicates the local apparatus, rewriting the destination to be the communication apparatus (Primary) 20, and deleting the “transfer request to communication apparatus (Primary) 20” from the data in the message. The packet transmission/reception unit 16 of the relay apparatus Relay 1-2 transmits the VLAN setting request Packet 3 to the communication apparatus (Primary) 20 (step S206). Additionally, the VLAN-ID setting unit 14 of the relay apparatus Relay 1-2 checks the LLDP data table recorded in the database 106 of the local apparatus and identifies the port number linked to the relay apparatus Relay 1-1 and the port number linked to the communication apparatus (Primary) 20. The VLAN-ID setting unit 14 of the relay apparatus Relay 1-2 sets the VLAN-ID:100 to the ports with the identified port numbers (step S207). When the setting of the VLAN-ID:100 is completed, the packet preparation unit 12 of the relay apparatus Relay 1-2 reads reply destination information indicating a “reply request to Primary 10” in the message in the received VLAN setting request Packet 2, and generates a setting result (success/failure) 2. The packet transmission/reception unit 16 of the relay apparatus Relay 1-2 sends the setting result (success/failure) 2 back to the communication apparatus (Primary) 10 (step S208).

The communication apparatus (Primary) 20 receives the VLAN setting request Packet 3. The VLAN-ID setting unit 14 of the communication apparatus (Primary) 20 checks the LLDP data table recorded in the database 106 of the local apparatus and identifies the port number linked to the relay apparatus Relay 1-2. The VLAN-ID setting unit 14 of the communication apparatus (Primary) 20 sets the VLAN-ID:100 to the port with the identified port number (step S209). When the setting of the VLAN-ID:100 is completed, the packet preparation unit 12 of the communication apparatus (Primary) 20 reads reply destination information indicating a “reply request to Primary 10” in the message in the received VLAN setting request Packet 3, and generates a setting result (success/failure) 3. The packet transmission/reception unit 16 of the communication apparatus (Primary) 20 sends the setting result (success/failure) 3 back to the communication apparatus (Primary) 10 (step S210).

This process is one mode of a process for using an identified VLAN-ID to set settings for communicably connecting relay apparatuses 30 and an opposing apparatus (communication apparatus 20) indicated by communication addresses on a single communication pathway using a new VLAN. When setting results (success) have been received from all of the communication apparatuses (including the relay apparatuses) constituting the communication pathway Relay Link 1 and the setting process has been completed, the VLAN-ID setting unit 14 of the communication apparatus (Primary) 10 identifies the next communication pathway Relay Link 2, in which the setting of which has not been completed, based on MTA group pathway information. Then, the communication apparatus 10 performs the above-described process for the identified communication pathway Relay Link 2 in a manner similar to that on the communication pathway Relay Link 1. Additionally, when the setting of VLAN-IDs has been completed for all of the communication pathways Relay Link based on the MTA group pathway information, the VLAN-ID setting unit 14 of the communication apparatus (Primary) 10 terminates the process. In the case in which a setting result (failure) has been received from a certain communication apparatus on a communication pathway Relay Link, the VLAN-ID setting unit 14 of the communication apparatus (Primary) 10 may output failure information for notifying an operator or may repeat the setting process again.

Due to the processes indicated above, the communication system 100 automatically sets a VLAN-ID to each relevant port in each apparatus on each of the Relay Link pathways by repeating the above-mentioned process for all of the communication pathways Relay Link.

In the process described above, when a VLAN information acquisition request is received, the packet transmission/reception unit 16 requests the VLAN information acquisition unit 13 to acquire used VLAN-IDs, and requests the packet preparation unit 12 to prepare a response packet.

Additionally, when a VLAN-ID setting request is received, the packet transmission/reception unit 16 requests the VLAN-ID setting unit to set a VLAN-ID to the relevant port, and requests the packet preparation unit 12 to prepare a setting result (success/failure) packet.

Additionally, when information indicating a transfer request is included in a message, the packet transmission/reception unit 16 requests the packet preparation unit 12 to prepare a transfer packet.

Additionally, when all of the response packets have been received, the packet transmission/reception unit 16 requests the VLAN information acquisition unit 13 to acquire used VLAN-IDs, and after collecting all of the used VLAN information of the relevant Relay Link, requests the available VLAN discovery processing unit 15 to discover available VLANs and requests the packet preparation unit 12 to prepare a VLAN setting request packet.

Additionally, when setting results (success/failure) are received, if all of the setting results indicate success, the packet transmission/reception unit 16 requests the packet preparation unit 12 to prepare a VLAN information request packet to the next Relay Link (the process ends if there is not a next Relay Link).

According to the process described above, VLAN-IDs can be automatically set for the relevant ports in all of the apparatuses on all of the Relay Link pathways configuring an MTA. Therefore, bothersome work can be automated and exclusive VLAN-IDs for configuring the MTA can be accurately and speedily set.

In the above-described process, the communication apparatus (Primary) 10 performs a process for identifying VLAN-IDs that are not being used by the relay apparatuses (Relay) 30 and the communication apparatus (Primary) 20. However, the relay apparatuses (Relay) 30 and the communication apparatus (Primary) 20 themselves may identify VLAN-IDs that are not being used in communication pathways Relay Link and notify the communication apparatus (Primary) 10. In this case, the communication apparatus (Primary) 10 acquires, for communicably connecting with the opposing apparatus using VLANs on multiple communication pathways, the communication addresses of the opposing apparatus (communication apparatus (Primary) 20) and the relay apparatuses (Relay) 30 located on the communication pathways, and the communication apparatus (Primary) 20 that is the opposing apparatus and the relay apparatuses (Relay) 30 acquire and notify the communication apparatus (Primary) 10 of used VLAN-IDs that are already being utilized for configuring other VLANs in the relay apparatuses Relay located on the communication pathways and the communication apparatus (Primary) 20 that is the opposing apparatus. Then, the communication apparatus (Primary) 10 identifies a VLAN-ID that is not being utilized on said communication pathways based on the used VLAN-IDs that are already being utilized for configuring other VLANs by the local apparatus, the relay apparatuses (Relay) 30, and the communication apparatus (Primary) 20 that is the opposing apparatus. This identification may be performed by the communication apparatus (Primary) 20 or by specific relay apparatuses 30. The communication apparatus 10, the relay apparatuses 30, and the communication apparatus 20 use the identified VLAN-ID to set ports for communicably connecting on one communication pathway using a new VLAN.

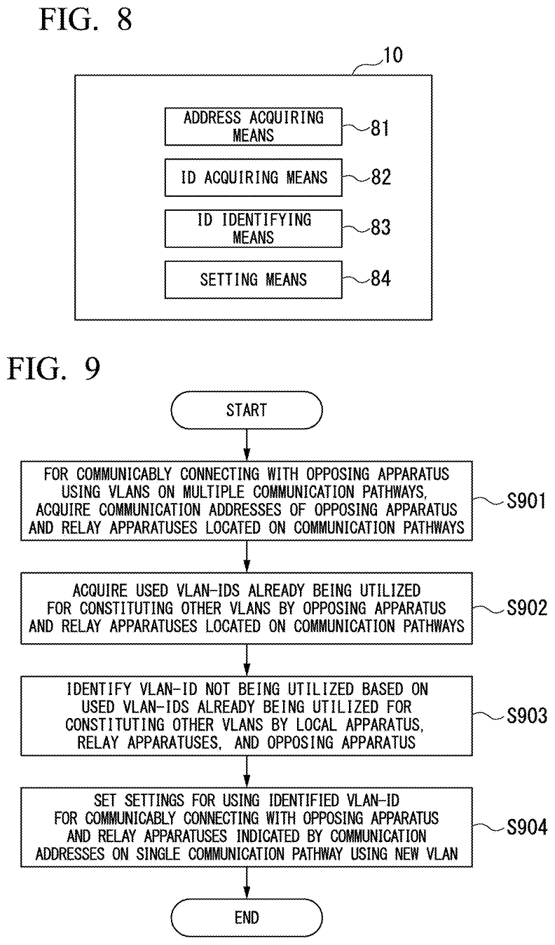

FIG. 8 is a diagram indicating the minimum configuration of a communication apparatus.

FIG. 9 is a diagram indicating the processing flow by the communication apparatus with the minimum configuration.

A communication apparatus 10, as illustrated in FIG. 8, is provided with at least an address acquiring means 81, an ID acquiring means 82, an ID identifying means 83, and a setting means 84.

The address acquiring means 81, for communicably connecting with an opposing apparatus using VLANs on multiple communication pathways, acquires communication addresses of the opposing apparatus, and relay apparatuses located on the communication pathways (step S901).

The ID acquiring means 82 acquires used VLAN-IDs already being utilized for configuring other VLANs by the opposing apparatus and the relay apparatuses located on the communication pathways (step S902).

The ID identifying means 83 identifies a VLAN-ID that is not being utilized based on the used VLAN-IDs that are already being utilized for configuring other VLANs by a local apparatus, the relay apparatuses, and the opposing apparatus (step S903).

The setting means 84 uses the identified VLAN-ID to set settings for communicably connecting the opposing apparatus and the relay apparatuses indicated by the communication addresses on a single communication pathway using a new VLAN (step S904).

The communication apparatuses 10, 20 and the relay apparatuses 30 (1-1, 1-2, 2-1, 2-2, 2-3, 2-4, 3-1, 3-2, 4-1, 4-2, 4-3, 4-4) described above have internal computer systems. Furthermore, the steps in the respective processes mentioned above are stored, in the form of a program, on computer-readable storage media, and the above-described processes are performed by a computer reading out and executing this program.

The above-described program may be for realizing just some of the aforementioned functions. Furthermore, it may be a so-called difference file (difference program) that can realize the aforementioned functions in combination with a program already recorded on the computer system.

The whole or part of the example embodiments disclosed above can be described as, but not limited to, the following appendixes.

### APPENDIX 1

A communication apparatus comprising: at least one memory configured to store instructions; and at least one processor configured to execute the instructions to: acquire, for communicably connecting with an opposing apparatus using Virtual Local Area Networks (VLANs) on multiple communication pathways, communication addresses of the opposing apparatus and relay apparatuses located on the communication pathways; acquire used VLAN-IDs already being utilized for constituting other VLANs by the opposing apparatus and the relay apparatuses located on the communication pathways; identify a VLAN-ID that is not being utilized based on the used VLAN-IDs that are already being utilized for constituting other VLANs by a local apparatus, the relay apparatuses, and the opposing apparatus; and set, using the identified VLAN-ID, settings for communicably connecting the opposing apparatus and the relay apparatuses indicated by the communication addresses on a single communication pathway using a new VLAN.

### APPENDIX 2

The communication apparatus according to Appendix 1, wherein the at least one processor is configured to: identify the VLAN-ID that is not being utilized when the used VLAN-IDs associated with the opposing apparatus and all of the relay apparatuses on the communication pathways have been acquired.

### APPENDIX 3

The communication apparatus according to Appendix 1 or Appendix 2, wherein the at least one processor is further configured to: generate first packet information including an acquisition request for the used VLAN-IDs and a transfer request to a communication apparatus that is to be directly connected among the communication apparatuses, indicating one of the relay apparatuses and the opposing apparatus; and transmit the first packet information to a communication apparatus directly connected to the local apparatus on the communication pathways.

### APPENDIX 4

The communication apparatus according to Appendix 1 or Appendix 2, wherein the at least one processor is further configured to: generate second packet information including a setting request for the identified VLAN-ID and a transfer request to a communication apparatus that is to be directly connected among the communication apparatuses, indicating one of the relay apparatuses and the opposing apparatus; and transmit the second packet information to a communication apparatus directly connected to the local apparatus on the communication pathways.

### APPENDIX 5

The communication apparatus according to Appendix 1, wherein: a multi-traffic aggregation is configured by the multiple communication pathways using the identified VLAN-ID.

### APPENDIX 6

The communication apparatus according to Appendix 5, wherein: the multi-traffic aggregation is configured by communicably connecting with the opposing apparatus by using VLANs on communication pathways using multiple different communication modes.

Technology that can efficiently set VLAN-IDs in communication apparatuses in multiple communication pathways for configuring a multi-traffic aggregation as mentioned above is sought.

According to the present disclosure, for example, VLAN-IDs can be efficiently set in the respective communication apparatuses configuring multiple communication pathways.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. A communication apparatus comprising:
at least one memory configured to store instructions; and
at least one processor configured to execute the instructions to:
acquire, for communicably connecting with an opposing apparatus using Virtual Local Area Networks (VLANs) on multiple communication pathways, communication addresses of the opposing apparatus and relay apparatuses located on the communication pathways;
acquire used VLAN-IDs already being utilized for configuring other VLANs by the opposing apparatus and the relay apparatuses located on the communication pathways;
identify a VLAN-ID that is not being utilized based on the used VLAN-IDs that are already being utilized for configuring other VLANs by a local apparatus, the relay apparatuses, and the opposing apparatus; and
set, using the identified VLAN-ID, settings for communicably connecting the opposing apparatus and the relay apparatuses indicated by the communication addresses on a single communication pathway using a new VLAN.

2. The communication apparatus according to claim 1, wherein the at least one processor is configured to:
identify the VLAN-ID that is not being utilized when the used VLAN-IDs associated with the opposing apparatus and all of the relay apparatuses on the communication pathways have been acquired.

3. The communication apparatus according to claim 1, wherein the at least one processor is further configured to:
generate first packet information including an acquisition request for the used VLAN-IDs and a transfer request to a communication apparatus that is to be directly connected among the communication apparatuses, indicating one of the relay apparatuses and the opposing apparatus; and
transmit the first packet information to a communication apparatus directly connected to the local apparatus on the communication pathways.

4. The communication apparatus according to claim 1, wherein the at least one processor is further configured to:
generate second packet information including a setting request for the identified VLAN-ID and a transfer request to a communication apparatus that is to be directly connected among the communication apparatuses, indicating one of the relay apparatuses and the opposing apparatus; and
transmit the second packet information to a communication apparatus directly connected to the local apparatus on the communication pathways.

5. The communication apparatus according to claim 1, wherein:
a multi-traffic aggregation is configured by the multiple communication pathways using the identified VLAN-ID.

6. The communication apparatus according to claim 5, wherein:
the multi-traffic aggregation is configured by communicably connecting with the opposing apparatus by using VLANs on communication pathways using multiple different communication modes.

7. A communication setting method comprising:
acquiring, for communicably connecting with an opposing apparatus using VLANs (Virtual Local Area Networks) on multiple communication pathways, communication addresses of the opposing apparatus and relay apparatuses located on the communication pathways;
acquiring used VLAN-IDs already being utilized for configuring other VLANs by the opposing apparatus and the relay apparatuses located on the communication pathways;
identifying a VLAN-ID that is not being utilized based on the used VLAN-IDs that are already being utilized for configuring other VLANs by a local apparatus, the relay apparatuses, and the opposing apparatus; and
setting, using the identified VLAN-ID, settings for communicably connecting the opposing apparatus and the relay apparatuses indicated by the communication addresses on a single communication pathway using a new VLAN.

8. A non-transitory computer-readable storage medium that stores a program that causes a computer in a communication apparatus to execute processes, the processes comprising:
acquiring, for communicably connecting with an opposing apparatus using VLANs (Virtual Local Area Networks) on multiple communication pathways, communication addresses of the opposing apparatus and relay apparatuses located on the communication pathways;
acquiring used VLAN-IDs already being utilized for configuring other VLANs by the opposing apparatus and the relay apparatuses located on the communication pathways;
identifying a VLAN-ID that is not being utilized based on the used VLAN-IDs that are already being utilized for configuring other VLANs by a local apparatus, the relay apparatuses, and the opposing apparatus; and
setting, using the identified VLAN-ID, settings for communicably connecting the opposing apparatus and the relay apparatuses indicated by the communication addresses on a single communication pathway using a new VLAN.
